(19) United States
(12) Patent Application Publication
(10) Pub. No.: US 2016/0118654 A1
(43) Pub. Date: Apr. 28, 2016

(54) BCC METAL HYDRIDE ALLOYS FOR ELECTROCHEMICAL APPLICATIONS

(71) Applicant: Ovonic Battery Company, Inc., Rochester Hills, MI (US)

(72) Inventors: Kwo-hsiung Young, Troy, MI (US); Taihei Ouchi, Oakland Township, MI (US); Baoquan Huang, Troy, MI (US)

(21) Appl. No.: 14/522,832

(22) Filed: Oct. 24, 2014

(51) Int. Cl. H01M 4/38; C22C 30/00; H01M 4/90

(52) U.S. Cl. CPC H01M 4/383; H01M 4/9041; C22C 30/00

(57) ABSTRACT

BCC metal hydride alloys historically have limited electrochemical capabilities. Provided are a new examples of these alloys useful as electrode active materials. BCC metal hydride alloys provided include a pressure plateau in the desorption PCT isotherm measured at 30° C. with center between 0.1 MPa and 1.0 MPa, and/or a plateau region between 0.05 weight percent to 0.5 weight percent of H₂. This pressure plateau represents a new catalytic phase capable of producing increased capacity in the absence of additional catalytic phases.

### FIELD OF THE INVENTION

This disclosure relates to alloy materials and methods for their fabrication. In particular, the disclosure relates to metal hydride alloy materials that are capable of absorbing and desorbing hydrogen. Activated metal hydride alloys with a body centered cubic (BCC) structure are provided that have unique electrochemical properties including high capacity for use in electrochemical applications.

### BACKGROUND OF THE INVENTION

Certain metal hydride (MH) alloy materials are capable of absorbing and desorbing hydrogen. These materials can be used as hydrogen storage media, and/or as electrode materials for fuel cells and metal hydride batteries including nickel/metal hydride (Ni/MH) and metal hydride/air battery systems. However, due to limited gravimetric energy density (<110 Wh kg⁻¹), current Ni/MH batteries lose market share in portable electronic devices and the battery-powered electrical vehicle markets to the lighter Li-ion technology. As such, the next generation of Ni/MH batteries is geared toward improving two main targets: raising the energy density and lowering cost.

When an electrical potential is applied between the cathode and a MH anode in a MH cell, the negative electrode material (M) is charged by the electrochemical absorption of hydrogen to form a MH and the electrochemical evolution of a hydroxyl ion. Upon discharge, the stored hydrogen is released to form a water molecule and evolve an electron. The reactions that take place at the positive electrode of a Ni/MH cell are also reversible. Most Ni/MH cells use a nickel hydroxide positive electrode. The following charge and discharge reactions take place at a nickel hydroxide positive electrode.

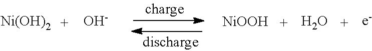

In a Ni/MH cell having a nickel hydroxide positive electrode and a hydrogen storage negative electrode, the electrodes are typically separated by a non-woven, felted, nylon or polypropylene separator. The electrolyte is usually an alkaline aqueous electrolyte, for example, 20 to 45 weight percent potassium hydroxide.

One particular group of MH materials having utility in Ni/MH battery systems is known as the ABₓ class of material with reference to the crystalline sites occupied by its member component elements. ABₓ type materials are disclosed, for example, in U.S. Pat. No. 5,536,591 and U.S. Pat. No. 6,210,498. Such materials may include, but are not limited to, modified LaNi₅ type (AB₅) as well as the Laves-phase based active materials (AB₂). These materials reversibly form hydrides in order to store hydrogen. Such materials utilize a generic Ti—Zr—Ni composition, where at least Ti, Zr, and Ni are present with at least one or more modifiers from the group of Cr, Mn, Co, V, and Al. The materials are multiphase materials, which may contain, but are not limited to, one or more Laves phase crystal structures and other non-Laves secondary phase. Current AB₅ alloys have ˜320 mAh g⁻¹ capacity and Laves-phase based AB₂ has a capacity up to 440 mAh g⁻¹ such that these are the most promising alloy alternatives with a good balance among high-rate dischargeability (HRD), cycle life, charge retention, activation, self discharge, and applicable temperature range.

Rare earth (RE) magnesium-based AB₃- or A₂B₇-types of MH alloys are promising candidates to replace the currently used AB₅ MH alloys as negative electrodes in Ni/MH batteries due in part to their higher capacities. While most of the RE-Mg—Ni MH alloys were based on La-only as the rare earth metal, some Nd-only A₂B₇ (AB₃) alloys have recently been reported. In these materials, the AB_{3.5} stoichiometry is considered to provide the best overall balance among storage capacity, activation, HRD, charge retention, and cycle stability. The pressure-concentration-temperature (PCT) isotherm of one Nd-only A₂B₇ alloy showed a very sharp take-off angle at the α-phase [K. Young, et al., Alloys Compd. 2010; 506: 831] which can maintain a relatively high voltage during a low state-of-charge condition. Compared to commercially available AB₅ MH alloys, a Nd-only A₂B₇ exhibited a higher positive electrode utilization rate and less resistance increase during a 60° C. storage, but also suffered higher capacity degradation during cycling [K. Young, et al., Int. J. Hydrogen Energy, 2012; 37:9882]. Another issue with known A₂B₇ alloys is that they suffer from inferior HRD relative to the prior AB₅ alloy systems due to less Ni-content in the alloy chemical make-up.

Other ABₓ materials include the Laves phase-related body centered cubic (BCC) materials that are a family of MH alloys with a two-phase microstructure including a BCC phase and a Laves phase historically present as C14 as an example. These materials are historically based on a theoretical electrochemical capacity of 1072 mAh g⁻¹ for an alloy with full BCC structure. To correct for the poor electrochemical properties of prior examples of such alloys, Laves phase with similar chemical make-up is added to the BCC material. These Laves phase-related BCC materials exhibit high density of the phase boundaries that allow the combination of higher hydrogen storage capacity of BCC and good hydrogen absorption kinetics and relatively high surface catalytic activity of the C14 phase. Many studies have been undertaken to optimize these materials. Young et al., Int. J. Hydrogen Energy, http://dx.doi.org/10.1016/j.ijhydene.2014.01.134 (article in press) describes a systematic study of these materials with a broad range of BCC/C14 ratio. These results reveal that while these materials have many desirable properties, the electrochemical discharge capacity produced by these materials does not exceed 175 mAh/g.

As such, there is a need for improved hydrogen storage materials. As will be explained herein below, the present invention addresses these needs by providing activated BCC metal hydride alloys that for the first time exhibit greatly improved electrochemical properties. These and other advantages of the invention will be apparent from the drawings, discussion, and description which follow.

### SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

Provided are BCC structured metal hydride alloy materials that exhibit excellent initial capacity. Such BCC metal hydride alloys according to some aspects comprise a pressure plateau in the desorption PCT isotherm measured at 30° C. with center between 0.1 MPa and 1.0 MPa and/or a plateau region between 0.05 weight percent to 0.5 weight percent of H₂. The alloys are optionally free of electrochemically active secondary phase. In some aspects, an alloy comprises an initial capacity of 70 milliampere hours per gram or greater, optionally 100 milliampere hours per gram or greater, optionally 200 milliampere hours per gram or greater. In some aspects, an alloy comprises a modifier effective to enlarge the unit cell, optionally the element B, Zr, Mo, Nb, or combinations thereof. In some aspects, the alloy comprises the composition of Formula I:

Ti_{w}VₓCr_{y}M_{z} (I)

where w+x+y+z=1, 0.1≦w≦0.6, 0.1≦x≦0.6, 0.01≦y≦0.6, and M comprises an element selected from the group consisting of Mn, Al, Si, Sn, and transition metals. M optionally further comprises a modifier selected from the group consisting of B, Zr, Mo, Nb, or combinations thereof. In some aspects, the alloy comprises a composition of Formula II: Ti₄₀V₃₀Cr₁₅Mn₁₃X₂ (II), where X═B, Zr, Nb, or Mo.

Also provided are metal hydride alloys comprising 90 percent BCC phase or greater and a capacity 60 milliampere hours per gram or greater measured at 25 degrees Celsius, optionally at or greater than 95 percent BCC phase, optionally at or greater than 99 percent BCC phase. An alloy optionally includes a capacity of 100 milliampere hours per gram or greater measured at 25 degrees Celsius, optionally 200 milliampere hours per gram or greater. An alloy optionally comprises a pressure plateau in the desorption PCT isotherm measured at 30° C. with center between 0.1 MPa and 1.0 MPa and/or a plateau region between 0.05 weight percent to 0.5 weight percent of H₂.

The alloys provided and their equivalents represent superior materials for use in an anode of a cell or battery system.

### BRIEF DESCRIPTION OF THE DRAWINGS

FIG. 1 illustrates XRD patterns using Cu—Kₐ as the radiation source for alloys Ti₄₀V₃₀Cr₁₅Mn₁₃X₂, where X═B (a), Si (b), Mn (c), Ni (d), Zr (e), Nb (f), Mo (g), and La (h). and where the vertical line is used to indicate shifts in the BCC (110) with respect to that in Ti₄₀V₃₀Cr₁₅Mn₁₅ alloy;

FIG. 2 illustrates the linear relationship between the BCC lattice constant a and the atomic radius of the substituting element illustrating the linear dependence when X is a transition metal;

FIG. 3A illustrates SEM back-scattering electron images for alloy Ti₄₀V₃₀Cr₁₅Mn₁₃B₂;

FIG. 3B illustrates SEM back-scattering electron images for alloy Ti₄₀V30Cr₁₅Mn13Si₂;

FIG. 3C illustrates SEM back-scattering electron images for alloy Ti₄₀V₃₀Cr₁₅Mn₁₃Mn₂;

FIG. 3D illustrates SEM back-scattering electron images for alloy Ti₄₀V₃₀Cr₁₅Mn₁₃Ni₂;

FIG. 3E illustrates SEM back-scattering electron images for alloy Ti₄₀V₃₀Cr₁₅Mn₁₃Zr₂;

FIG. 3F illustrates SEM back-scattering electron images for alloy Ti₄₀V₃₀Cr₁₅Mn₁₃Nb₂;

FIG. 3G illustrates SEM back-scattering electron images for alloy Ti₄₀V₃₀Cr₁₅Mn₁₃Mo₂;

FIG. 3H illustrates SEM back-scattering electron images for alloy Ti₄₀V₃₀Cr₁₅Mn₁₃La₂;

FIG. 4A illustrates PCT isotherms measured at 30° C. (both before and after 400° C. degasing), 60° C. and 90° C. for alloys Ti₄₀V₃₀Cr₁₅Mn₁₃B₂, where open and solid symbols are for absorption and desorption curves, respectively;

FIG. 4B illustrates PCT isotherms measured at 30° C. (both before and after 400° C. degasing), 60° C. and 90° C. for alloys Ti₄₀V₃₀Cr₁₅Mn₁₃Si₂, where open and solid symbols are for absorption and desorption curves, respectively;

FIG. 4C illustrates PCT isotherms measured at 30° C. (both before and after 400° C. degasing), 60° C. and 90° C. for alloys Ti₄₀V₃₀Cr₁₅Mn₁₃Mn₂, where open and solid symbols are for absorption and desorption curves, respectively;

FIG. 4D illustrates PCT isotherms measured at 30° C. (both before and after 400° C. degasing), 60° C. and 90° C. for alloys Ti₄₀V₃₀Cr₁₅Mn₁₃Ni₂, where open and solid symbols are for absorption and desorption curves, respectively;

FIG. 4E illustrates PCT isotherms measured at 30° C. (both before and after 400° C. degasing), 60° C. and 90° C. for alloys Ti₄₀V₃₀Cr₁₅Mn₁₃Zr₂, where open and solid symbols are for absorption and desorption curves, respectively;

FIG. 4F illustrates PCT isotherms measured at 30° C. (both before and after 400° C. degasing), 60° C. and 90° C. for alloys Ti₄₀V₃₀Cr₁₅Mn₁₃Nb₂, where open and solid symbols are for absorption and desorption curves, respectively;

FIG. 4G illustrates PCT isotherms measured at 30° C. (both before and after 400° C. degasing), 60° C. and 90° C. for alloys Ti₄₀V₃₀Cr₁₅Mn₁₃Mo₂, where open and solid symbols are for absorption and desorption curves, respectively;

FIG. 4H illustrates PCT isotherms measured at 30° C. (both before and after 400° C. degasing), 60° C. and 90° C. for alloys Ti₄₀V₃₀Cr₁₅Mn₁₃La₂, where open and solid symbols are for absorption and desorption curves, respectively;

FIG. 5 illustrates the first cycle charge and discharge voltage profiles for alloy Ti₄₀V₃₀Cr₁₅Mn₁₃Mo₂; and

FIG. 6 illustrates the product of the BCC lattice constant and width of 0.3 MPa pressure plateau.

### BRIEF DESCRIPTION OF EMBODIMENTS OF THE INVENTION

The following description of particular embodiment(s) is merely exemplary in nature and is in no way intended to limit the scope of the invention, its application, or uses, which may, of course, vary. The invention is described with relation to the non-limiting definitions and terminology included herein. These definitions and terminology are not designed to function as a limitation on the scope or practice of the invention but are presented for illustrative and descriptive purposes only. While the processes or compositions are described as an order of individual steps or using specific materials, it is appreciated that steps or materials may be interchangeable such that the description of the invention may include multiple parts or steps arranged in many ways as is readily appreciated by one of skill in the art.

It will be understood that, although the terms “first,” “second,” “third” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second (or other) element, component, region, layer, or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

Unless otherwise defined, all terms (including technical and scientific terms) used herein have the same meaning as commonly understood by one of ordinary skill in the art to which this disclosure belongs. It will be further understood that terms such as those defined in commonly used dictionaries, should be interpreted as having a meaning that is consistent with their meaning in the context of the relevant art and the present disclosure, and will not be interpreted in an idealized or overly formal sense unless expressly so defined herein.

Hydrogen storage alloys having BCC structures have been studied for some time to identify how to capitalize on the high theoretical capacity of as much as 1072 mAh/g owing to the very high (up to 4.0 wt percent) hydrogen storage capacity. Due to the strong metal-hydrogen bonding and low surface reaction activity of BCC metal hydride alloys, few electrochemical studies have been performed. Inoue and his coworker reported a TiV_{3.4}Ni_{0.6} alloy achieving 360 mAh/g at room temperature with a discharge rate of 50 mA/g [3]. Mori and Iba improved both the capacity and cycle stability by adding Y, lanthanoids, Pd, or Pt into a TiCrVNi BCC alloy and reached 462 mAh/g [4]. Yu and his coworker reported a Ti₄₀V₃₀Cr₁₅Mn₁₅ alloy with an initial capacity of 814 mAh/g measured with a rate at 10 mA/g at 80° C.; however, degradation was high due to surface cracking and V leaching into KOH electrolyte leaving TiOₓ on the surface blocking further electrochemical reaction [5]. Secondary phases, such as C14, C15, and B2, with a high grain boundary density were developed to improve the absorption kinetics [6], to facilitate formation due to its brittleness [7-9], and to increase the surface catalytic activity [10, 11]) by increasing the synergetic effect between the two phases. The density of phase boundaries also promotes the formation of coherent and catalytic interfaces between BCC and the secondary phases, improving hydrogen absorption [12]. In contrast to these prior attempts, the alloys provided herein represent a simple and elegant solution to these problems by providing BCC structured metal hydride alloy materials that exhibit excellent initial capacity.

Provided are hydrogen storage alloys having a BCC structure that exhibits excellent initial capacity. In some aspects, a BCC metal hydride alloy exhibits a pressure plateau with a center between 0.1 MPa and 1.0 MPa and a plateau region between 0.05 weight percent to 0.5 weight percent of H₂ in the desorption PCT isotherm measured at 30° C. It was unexpectedly identified that such a pressure plateau represents a previously unknown catalytic phase during the hydrogenation process that participates wholly or in part in the electrochemical discharge capacity of the BCC metal hydride alloy. This phase enables the electrochemical application of the BCC alloys having greater than 90% BCC phase without electrochemical contributions from a secondary phase.

In some aspects, a BCC metal hydride alloy includes a pressure plateau in the desorption PCT isotherm measured at 30° C. with a center located at or between 0.1 MPa and 1.0 MPa, optionally at or between 0.2 MPa and 1.0 MPa, optionally at or between 0.3 MPa and 1.0 MPa, optionally at or between 0.4 MPa and 1.0 MPa, optionally at or between 0.5 MPa and 1.0 MPa, optionally at or between 0.6 MPa and 1.0 MPa, optionally at or between 0.1 MPa and 0.9 MPa, optionally at or between 0.1 MPa and 0.8 MPa, optionally at or between 0.1 MPa and 0.7 MPa, optionally at or between 0.1 MPa and 0.6MPa, optionally at or between 0.1 MPa and 0.5 MPa, optionally at or between 0.2 MPa and 0.6 MPa, optionally at or between 0.2 MPa and 0.5 MPa, optionally at or between 0.3 MPa and 0.5 MPa.

Optionally, the pressure plateau in the desorption PCT isotherm measured at 30° C. includes a plateau region located entirely or partially between 0.05 weight percent to 0.5 weight percent of H₂, optionally entirely or partially between 0.05 weight percent to 0.4 weight percent of H₂, optionally entirely or partially between 0.05 weight percent to 0.3 weight percent of H₂, optionally entirely or partially between 0.06 weight percent to 0.5 weight percent of H₂, optionally entirely or partially between 0.07 weight percent to 0.5 weight percent of H₂, optionally entirely or partially between 0.08 weight percent to 0.5 weight percent of H₂, optionally entirely or partially between 0.9 weight percent to 0.5 weight percent of H₂, optionally entirely or partially between 0.1 weight percent to 0.5 weight percent of H₂, optionally entirely or partially between 0.05 weight percent to 0.4 weight percent of H₂, optionally entirely or partially between 0.05 weight percent to 0.3 weight percent of H₂, optionally entirely or partially between 0.06 weight percent to 0.3 weight percent of H₂, optionally entirely or partially between 0.07 weight percent to 0.3 weight percent of H₂, optionally entirely or partially between 0.08 weight percent to 0.3 weight percent of H₂, optionally entirely or partially between 0.09 weight percent to 0.3 weight percent of H₂, optionally entirely or partially between 0.1 weight percent to 0.3 weight percent of H₂.

It is appreciated that the pressure plateau optionally has a center in any of the above ranges and has a plateau region in any of the above regions. In some aspects, a pressure plateau in the desorption PCT isotherm measured at 30° C. includes a center located between 0.1 MPa and 1.0 MPa and a plateau region entirely or partially between 0.05 weight percent to 0.5 weight percent of H₂, optionally a center between 0.2 and 0.5 MPa and the plateau region entirely or partially is between 0.05 weight percent to 0.5 weight percent of H₂, optionally a center between 0.2 and 0.5 MPa and the plateau region entirely or partially is between 0.1 weight percent to 0.3 weight percent of H₂.

In some aspects, a BCC metal hydride alloy is free of electrochemically active secondary phase. Optionally, the BCC phase is in 90% or greater abundance, optionally 95% or greater, optionally 99%, optionally 99.5% or greater in abundance, optionally as measured by X-ray diffraction analysis.

A BCC metal hydride alloy optionally illustrates excellent initial capacity. In some aspects, a BCC metal hydride alloy presents an initial capacity of 70 milliampere hours per gram or greater, optionally 100 milliampere hours per gram or greater, optionally 150 milliampere hours per gram or greater, optionally 180 milliampere hours per gram or greater, optionally 200 milliampere hours per gram or greater. In some aspects, a BCC metal hydride alloy presents an initial capacity of 240 milliampere hours per gram or greater.

A BCC metal hydride alloy optionally includes a modifier effective to enlarge the unit cell. Without being limited to one particular theory, it is believed that for the BCC metal hydride alloys displaying a pressure plateau with center between 0.1 MPa and 1.0 MPa in the desorption PCT isotherm measured at 30° C., the electrochemical capacity is closely related to the BCC phase unit cell volume. As such, a BCC metal hydride alloy optionally includes a modifier effective to enlarge the unit cell. A modifier is optionally B, Zr, Mo, Nb, or combinations thereof.

In some aspects a BCC metal hydride alloy comprises the composition of Formula I.

Ti_{w}VₓCr_{y}M_{z} (I)

where w+x+y+z=1, 0.1≦w≦0.6, 0.1≦x≦0.6, 0.01≦y≦0.6 and M is selected from the group consisting of Mn, Al, Si, Sn, and one or more transition metals. The alloy is activated by particular processes to promote formation of increased BCC phase in the resulting materials. The result is an activated metal hydride alloy displaying a pressure plateau in the desorption PCT isotherm measured at 30° C. with center between 0.1 MPa and 1.0 MPa, or any value or range therebetween, or a plateau region in the desorption PCT isotherm measured at 30° C. entirely or partially between 0.05 weight percent to 0.5 weight percent of H₂, or any value or range therebetween, or both. Such a BCC metal hydride alloy optionally includes improved electrochemical properties including an initial capacity at or in excess of 70 mAh/g, optionally 100 mAh/g, optionally 200 mAh/g or greater.

In some aspects, an alloy of Formula I comprises a modifier effective to enlarge the unit cell. A modifier is optionally selected from the group consisting of B, Zr, Mo, Nb, or combinations thereof.

In some aspects, a BCC metal hydride alloy comprises the composition of Formula II:

Ti₄₀V₃₀Cr₁₅Mn₁₃X₂ (II)

where X═B, Zr, Nb, or Mo. In particular aspects, X is B. In other aspects, X is Mo. In yet other aspects, X is Zr. Alloys of Formula II optionally display a pressure plateau in the desorption PCT isotherm measured at 30° C. with center between 0.1 MPa and 1.0 MPa, or any value or range therebetween, or a plateau region in the desorption PCT isotherm measured at 30° C. entirely or partially between 0.05 weight percent to 0.5 weight percent of H₂, or any value or range therebetween, or both. Such a BCC metal hydride alloy optionally includes improved electrochemical properties including an initial capacity at or in excess of 70 mAh/g, optionally 100 mAh/g, optionally 100 mAh/g or greater.

In some aspects, a BCC metal hydride alloy includes an initial capacity at or in excess of 60 mAh/g, optionally 70 mAh/g, 80 mAh/g, 90 mAh/g, 100 mAh/g, 110 mAh/g, 120 mAh/g, 130 mAh/g, 140 mAh/g, 150 mAh/g, 160 mAh/g, 170 mAh/g, 180 mAh/g, 190 mAh/g, 200 mAh/g, 210 mAh/g, 220 mAh/g, 230 mAh/g, 240 mAh/g, 250 mAh/g, 300 mAh/g, or more. Optionally, a metal hydride alloy includes an initial capacity between 60 and 250 mAh/g. Optionally, a metal hydride alloy includes a capacity between 100 and 250 mAh/g. Optionally, a metal hydride alloy includes a capacity between 200 and 250 mAh/g.

The physical structure of the material along with its including a pressure plateau in the desorption PCT isotherm measured at 30° C. as described is indicative of a substantially pure electrochemically active BCC phase that is capable of delivering excellent initial capacity in the absence of substantial or any electrochemically active secondary phase. In some aspects, a metal hydride alloy is predominantly formed of BCC phase. As such, the metal hydride alloy optionally includes a BCC phase in abundance of greater than 90%. Optionally, the BCC phase is at or between 90% and 100%, 90% and 95%, 92% and 95%, 95% and 99%, 90% and 99%, 95% and 99.8%, 99% and 99.8%, or 99.6% and 99.8%.

In some aspects, a metal hydride alloy is provided including greater than 90 percent BCC phase and a capacity 60 mAh/g or greater measured at 25° C. Such an alloy optionally includes an initial capacity of 60 mAh/g, optionally 70 mAh/g, 80 mAh/g, 90 mAh/g, 100 mAh/g, 110 mAh/g, 120 mAh/g, 130 mAh/g, 140 mAh/g, 150 mAh/g, 160 mAh/g, 170 mAh/g, 180 mAh/g, 190 mAh/g, 200 mAh/g, 210 mAh/g, 220 mAh/g, 230 mAh/g, 240 mAh/g, 250 mAh/g, 300 mAh/g, or more. Such a metal hydride alloy optionally includes BCC phase of 90% or greater. A BCC phase is optionally the sole catalytically active phase. Optionally, a BCC phase is present at 95% or greater, optionally 99%, optionally 99.5% or greater in abundance, optionally as measured by X-ray diffraction analysis. Optionally, a BCC phase is present at or between 90% and 100%, 90% and 95%, 92% and 95%, 95% and 99%, 90% and 99%, 95% and 99.8%, 99% and 99.8%, or 99.6% and 99.8%.

In some aspects, a metal hydride alloy including greater than 90 percent BCC phase and a capacity 60 mAh/g or greater measured at 25° C. includes a composition of Formula I where M is selected from the group consisting of Mn, Al, Si, Sn, and one or more transition metals. Such a BCC metal hydride alloy optionally includes improved electrochemical properties including an initial capacity at or in excess of 70 mAh/g, optionally 100 mAh/g, optionally 100 mAh/g or greater.

In some aspects, an alloy of Formula I comprises a modifier effective to enlarge the unit cell. A modifier is optionally selected from the group consisting of B, Zr, Mo, Nb, or combinations thereof.

In some aspects, a BCC metal hydride alloy including greater than 90 percent BCC phase and a capacity 60 mAh/g or greater measured at 25° C. comprises the composition of Formula II:

Ti₄₀V₃₀Cr₁₅Mn₁₃X₂ (II)

where X═B, Zr, Nb, or Mo. In particular aspects, X is B. In other aspects, X is Mo. In yet other aspects, X is Zr. Such a BCC metal hydride alloy optionally includes improved electrochemical properties including an initial capacity at or in excess of 70 mAh/g, optionally 100 mAh/g, optionally 100 mAh/g or greater.

The BCC metal hydride alloys possesses initial capacities that are well above that believed achievable in systems of 90% or greater BCC phase, optionally as the sole catalytically active phase.

Various aspects of the present invention are illustrated by the following non-limiting examples. The examples are for illustrative purposes and are not a limitation on any practice of the present invention. It will be understood that variations and modifications can be made without departing from the spirit and scope of the invention.

### EXPERIMENTAL

A series of metal hydride alloys of the formulas Ti₄₀V₃₀Cr₁₅Mn₁₃X₂, where X═B, Si, Mn, Ni, Zr, Nb, Mo, and La were prepared. The raw materials were arc melted under conditions of continuous argon flow using a non-consumable tungsten electrode and a water cooled copper tray. Prior to formation, the residual oxygen concentration in the system was reduced by subjecting a piece of sacrificial titanium to several melt-cool cycles. Study ingots where then subjected to several re-melt cycles with turning over to ensure uniformity in chemical composition.

### XRD Analyses

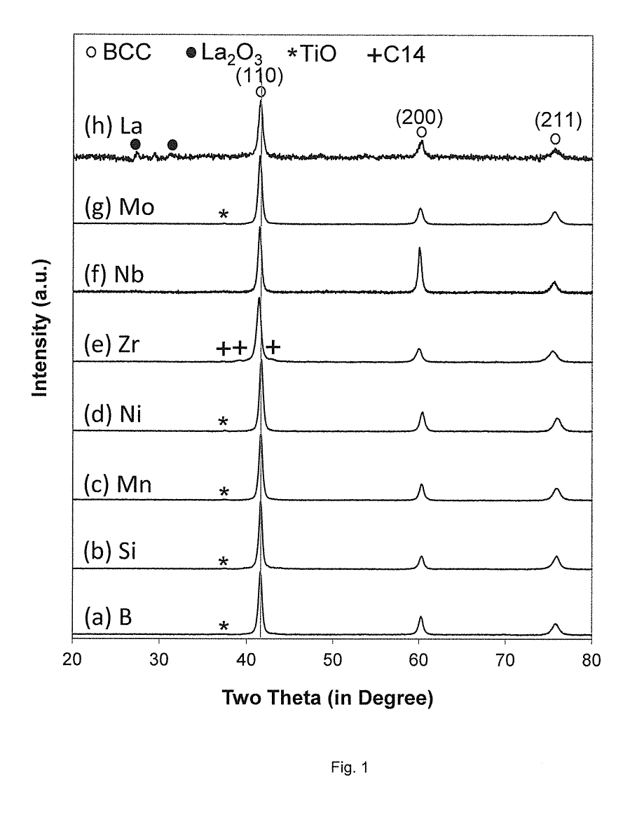

The metal hydride alloys were prepared as per above and their compositions were verified by ICP. Microstructure of the alloys was studied utilizing a Philips X'Pert Pro x-ray diffractometer. XRD patterns of these alloys before any high-temperature treatment are shown in FIG. 1. The patterns illustrate three major peaks that are each from a BCC structure. Peak intensity ratios are about the same, except for I(200)/I(110) in Alloy-Nb (partial replacement with Nb). Both elemental Nb and Mo have a BCC structure; however, only Alloy-Nb has this unusual, larger (200) peak. Besides the main phase, some secondary phase can be found in the XRD pattern of each alloy, except Alloy-Nb. The Rietveld refinement results from XRD analysis are summarized in Table 1.

TABLE 1
Summary of XRD results.

| | | | | | | Secondary |
|---|---|---|---|---|---|---|
| | a of | BCC | Sec- | a of | c of | phase |
| | BCC | abundance | ondary | Secondary | Secondary | abundance |
| X = | (Å) | (%) | phase | phase (Å) | phase (Å) | (%) |
| B | 3.0703 | 98.2 | TiO₂ | 4.1761 | 8.1790 | 1.8 |
| Si | 3.0679 | 96.9 | TiO₂ | 4.1472 | | 3.1 |
| Mn | 3.0687 | 98.9 | TiO₂ | 4.1687 | | 1.1 |
| Ni | 3.0649 | 99.7 | TiO₂ | 4.1567 | | 0.3 |
| Zr | 3.0839 | 98.2 | C14 | 4.9895 | | 1.8 |
| Nb | 3.0790 | 99.8 | TiO₂ | 4.1743 | | 0.2 |
| Mo | 3.0774 | 99.6 | TiO₂ | 4.1706 | | 0.4 |
| La | 3.0693 | 98.3 | La₂O₃ | 11.302 | | 1.7 |

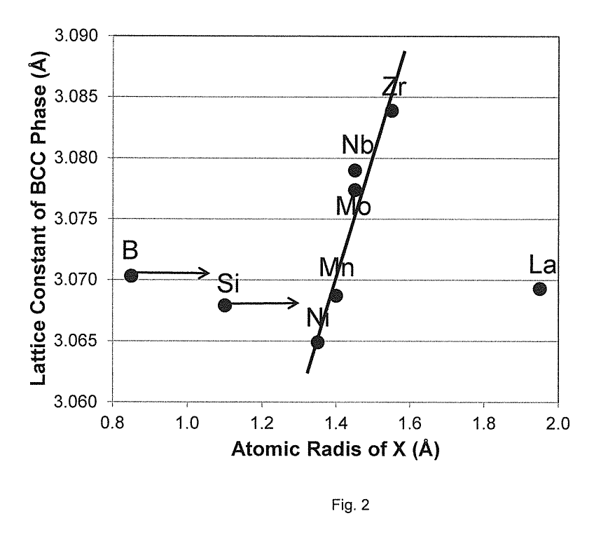

Lattice parameter a in BCC phase ranges from 3.0679 to 3.0839 Å. This lattice constant is plotted against the atomic radius of the substituting element in FIG. 2. All alloys substituted with transition metals form a linear relationship between the lattice constant and the atomic radius (straight line in FIG. 2). According to the result of Rietveld refinement, the BCC phase abundance in all alloys is above 96.9%. The majority secondary phase is TiO₂ with exception in Alloy-Zr (C14), Alloy-Ni (TiNi) and Alloy-La (La₂O₃).

### Phase Distribution and Composition

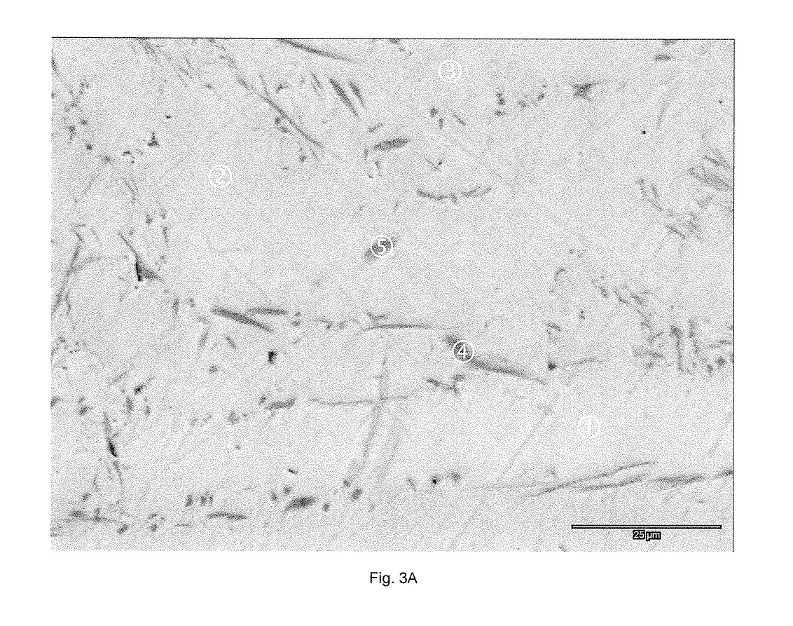

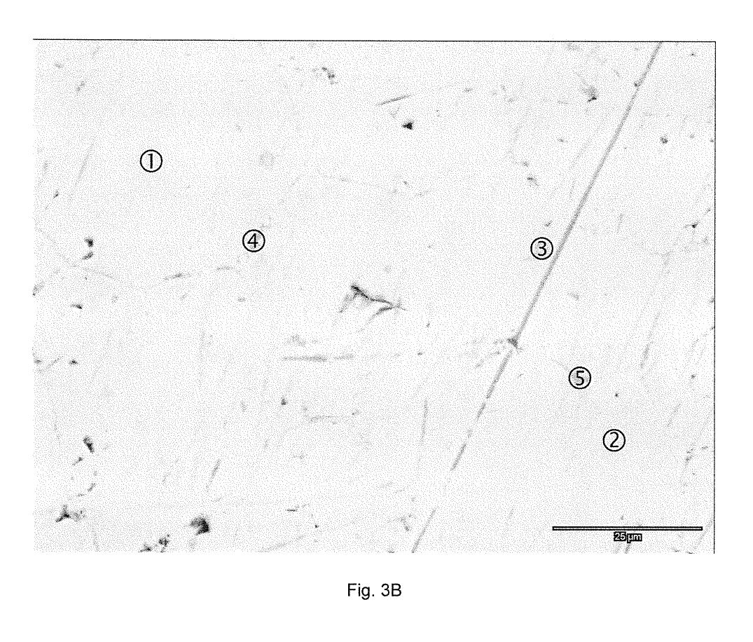

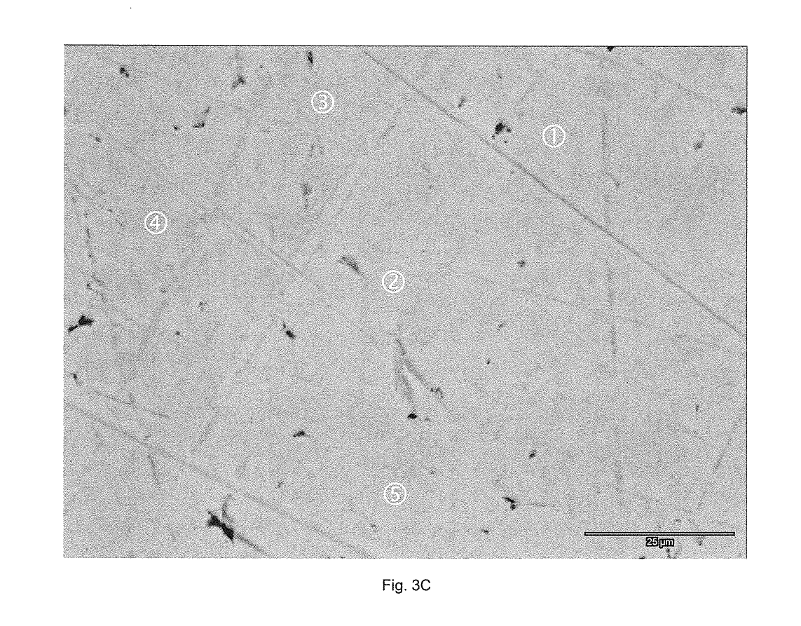

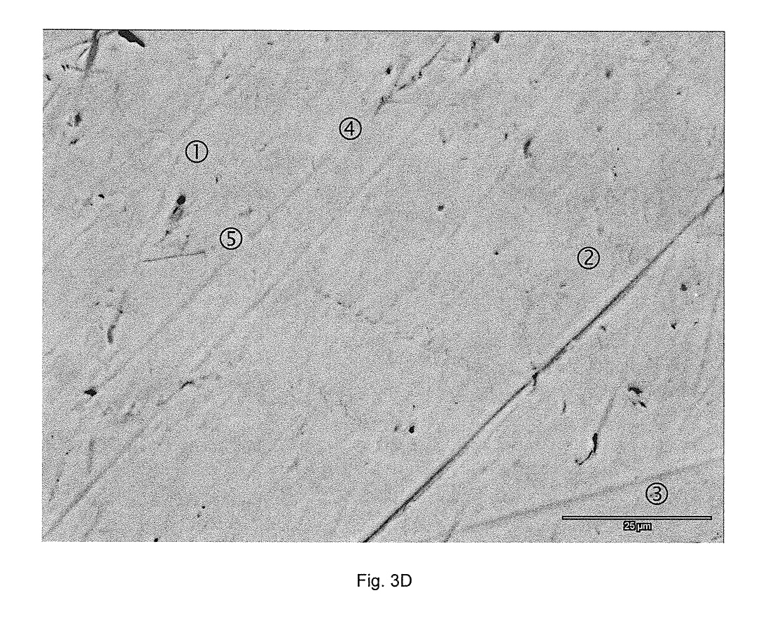

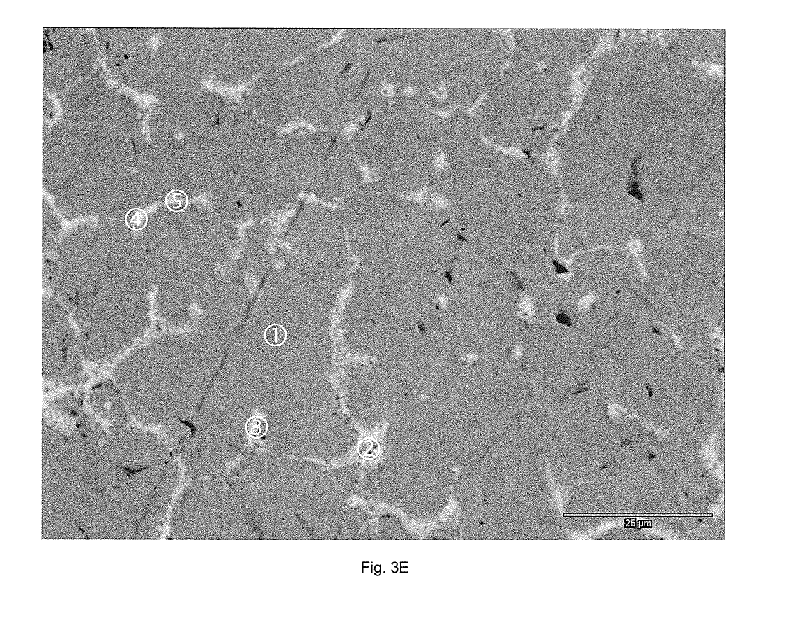

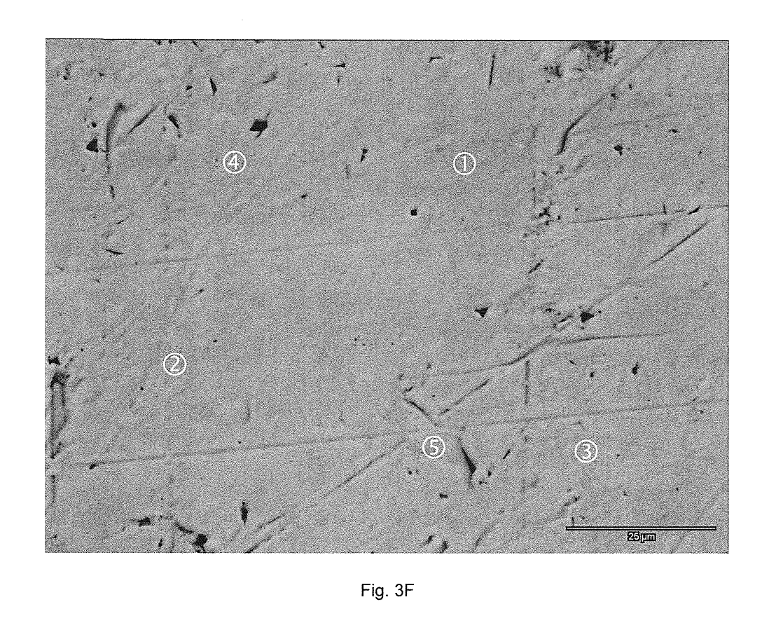

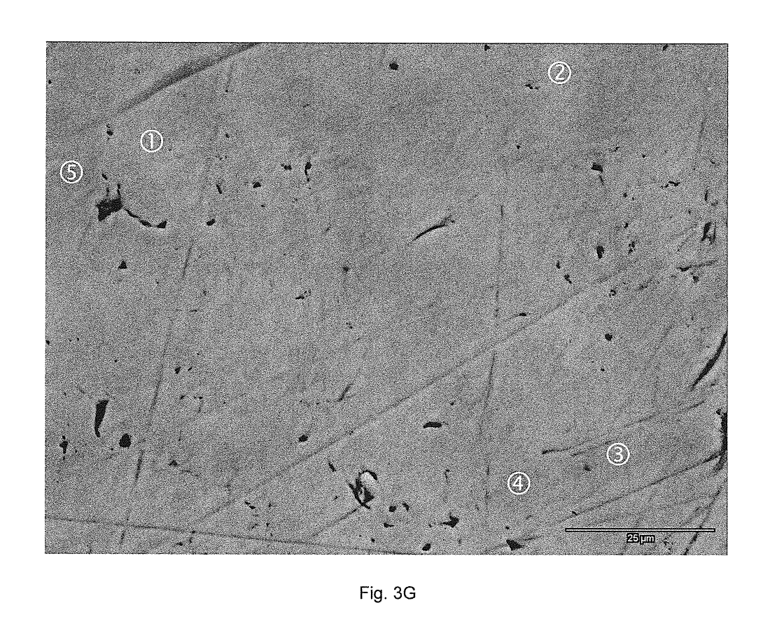

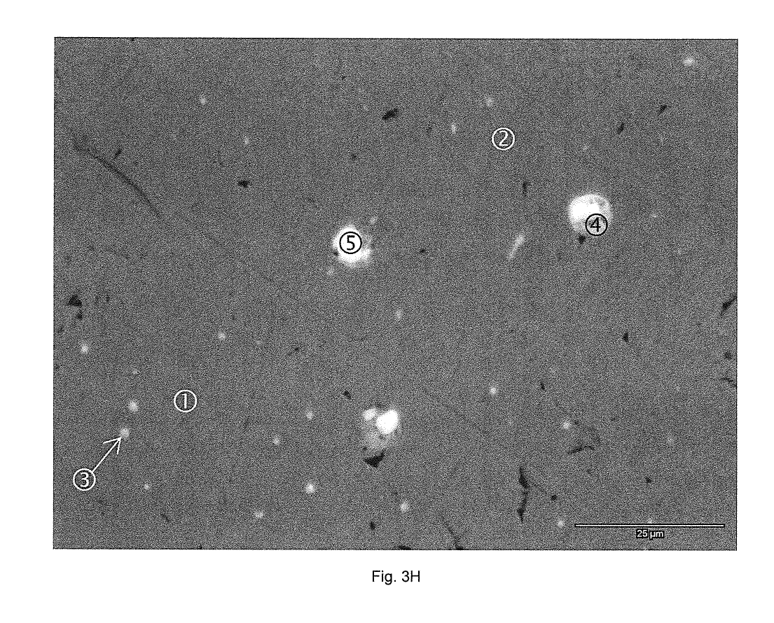

The alloy phase distribution and composition were examined using a JEOL-JSM6320F scanning electron microscope with energy dispersive spectroscopy (EDS) capability. Samples were mounted and polished on epoxy blocks, rinsed and dried before entering the SEM chamber. The back-scattering electron images (BEI) are presented in FIGS. 3A-H. Chemical compositions of a few selective spots, identified by a circled number in the SEI micrographs in FIGS. 3A-H, were studied by EDS, and the results are summarized in Table 2.

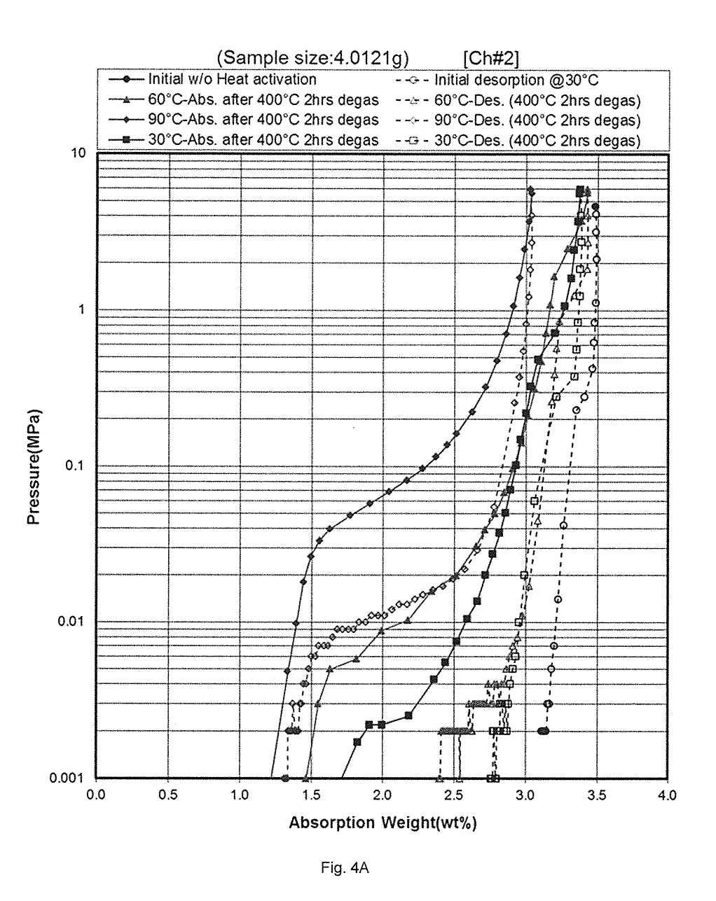

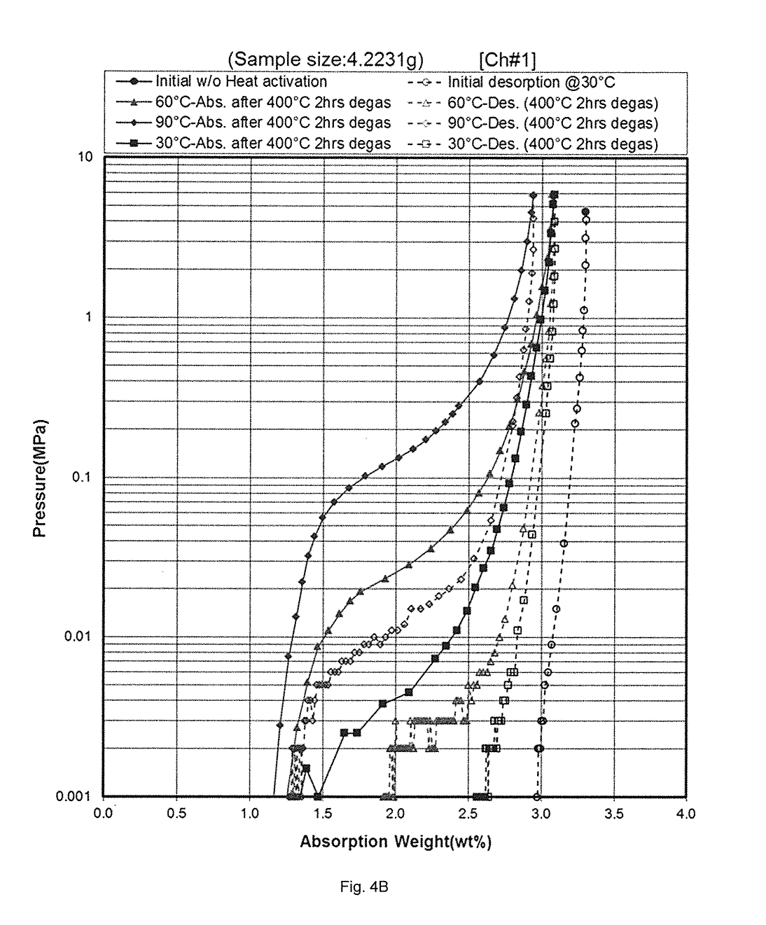

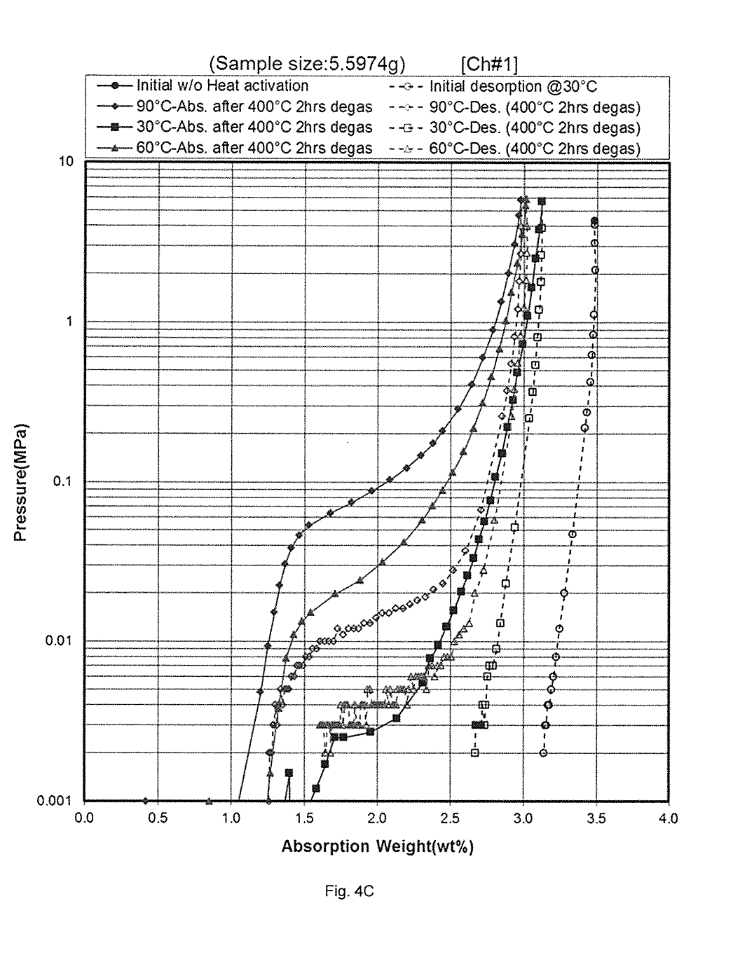

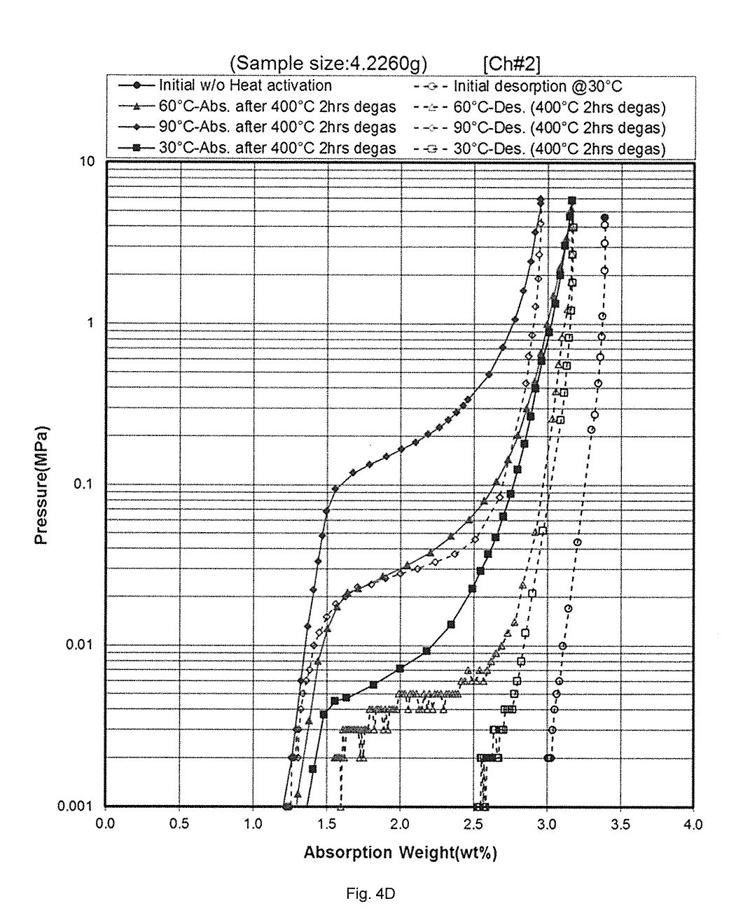

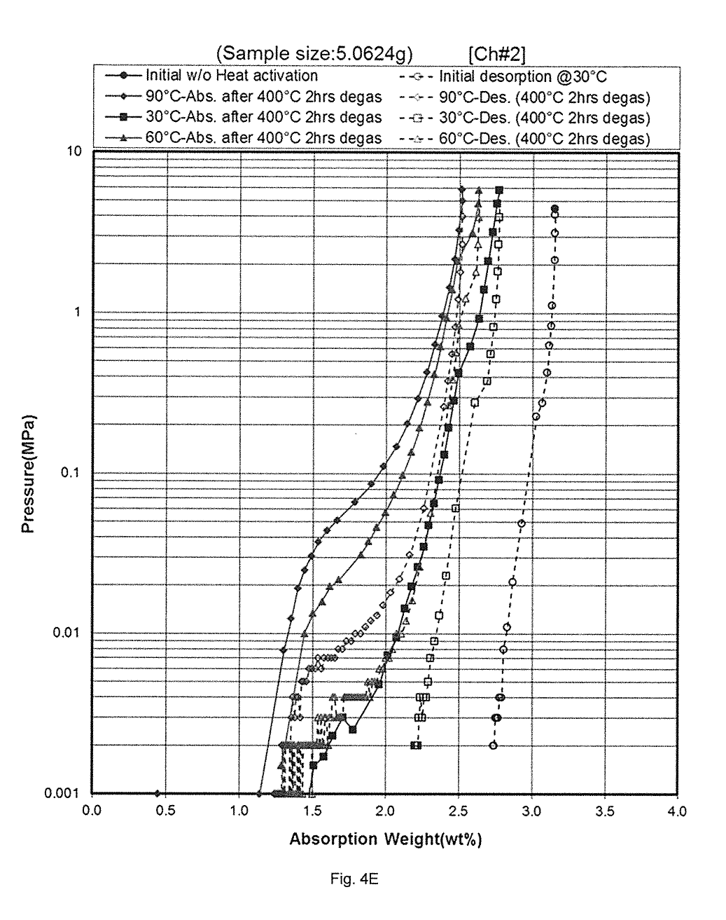

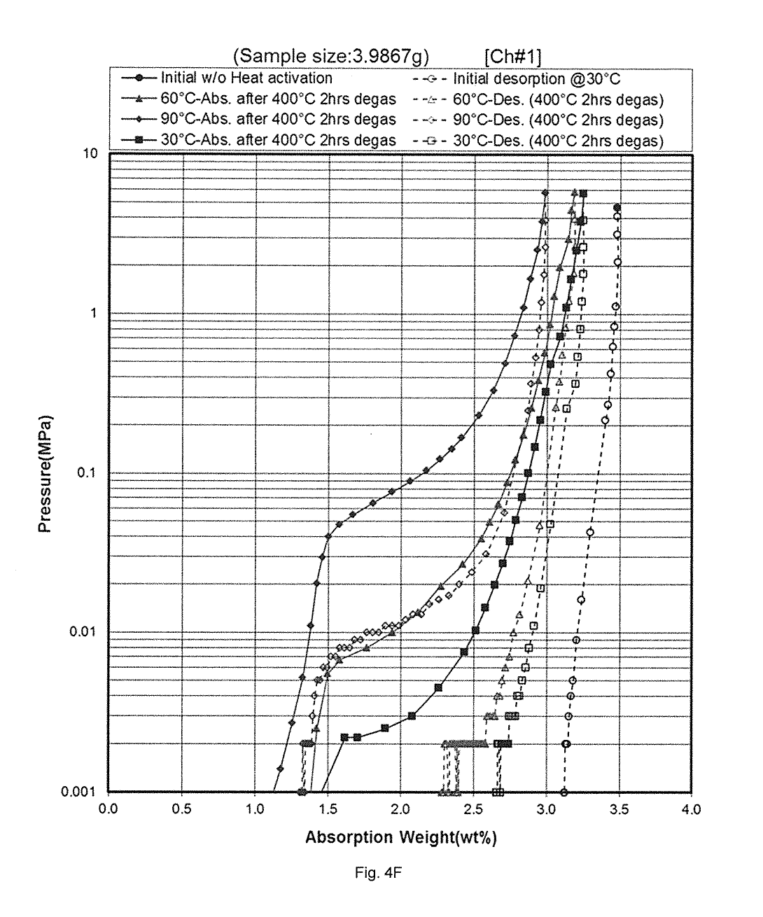

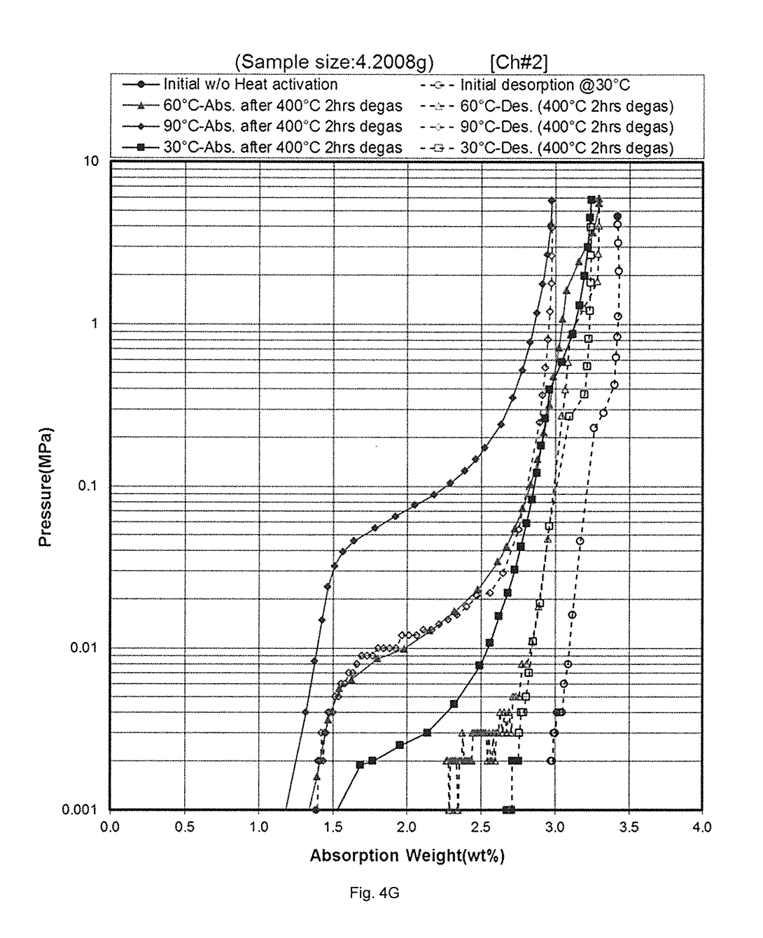

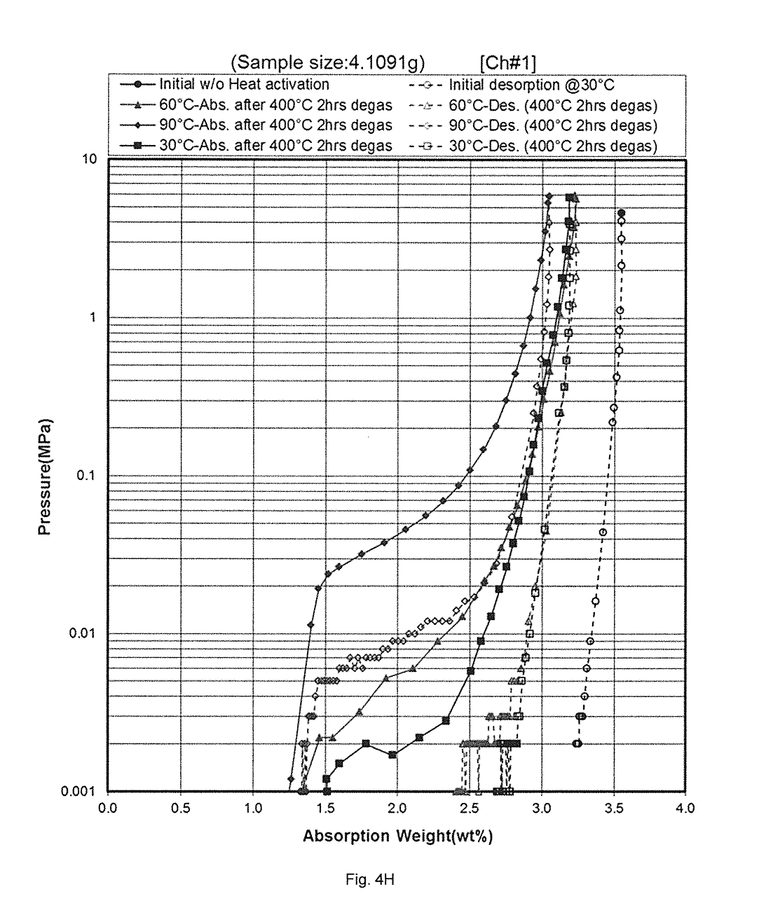

TABLE 2
Summary of EDS results. All compositions are in
atomic %. Compositions of BCC phase are in bold.

| | Ti | V | Cr | Mn | X | phase |
|---|---|---|---|---|---|---|
| FIG. 3a-1 | 41.1 | 29.3 | 16.7 | 12.9 | 0.0 | BCC |
| FIG. 3a-2 | 42.2 | 28.0 | 16.2 | 13.7 | 0.0 | BCC |
| FIG. 3a-3 | 42.2 | 28.2 | 16.3 | 13.3 | 0.0 | BCC |
| FIG. 3a-4 | 59.5 | 23.9 | 9.3 | 7.3 | 0.0 | Oxide |
| FIG. 3a-5 | 64.4 | 22.5 | 7.6 | 5.5 | 0.0 | Oxide |
| FIG. 3b-1 | 38.7 | 31.9 | 15.8 | 12.1 | 1.6 | Oxide |
| FIG. 3b-2 | 38.4 | 32.2 | 15.8 | 12.1 | 1.5 | BCC |
| FIG. 3b-3 | 49.7 | 15.4 | 12.0 | 15.4 | 7.5 | Oxide |
| FIG. 3b-4 | 55.8 | 15.3 | 10.5 | 12.6 | 5.8 | Oxide |
| FIG. 3b-5 | 55.6 | 17.4 | 10.2 | 11.5 | 5.2 | Oxide |
| FIG. 3c-1 | 38.8 | 30.1 | 15.8 | 15.3 | 0.0 | BCC |
| FIG. 3c-2 | 38.7 | 29.9 | 15.9 | 15.5 | 0.0 | BCC |
| FIG. 3c-3 | 41.6 | 26.4 | 14.9 | 17.0 | 0.0 | BCC |
| FIG. 3c-4 | 43.3 | 26.2 | 14.6 | 15.9 | 0.0 | BCC |
| FIG. 3c-5 | 42.1 | 25.9 | 14.9 | 17.1 | 0.0 | BCC |
| FIG. 3d-1 | 36.9 | 33.8 | 16.6 | 11.4 | 1.3 | BCC |
| FIG. 3d-2 | 38.6 | 31.9 | 16.1 | 12.0 | 1.3 | BCC |
| FIG. 3d-3 | 42.6 | 28.2 | 14.7 | 12.4 | 2.1 | BCC |
| FIG. 3d-4 | 51.1 | 16.8 | 10.0 | 12.6 | 9.4 | TiNi |
| FIG. 3d-5 | 57.9 | 9.1 | 5.9 | 11.2 | 16.0 | TiNi |
| FIG. 3e-1 | 39.7 | 31.3 | 15.7 | 12.1 | 1.1 | BCC |
| FIG. 3e-2 | 43.1 | 19.9 | 13.3 | 15.9 | 7.7 | C14 |
| FIG. 3e-3 | 32.9 | 19.3 | 16.7 | 20.4 | 10.6 | C14 |
| FIG. 3e-4 | 31.5 | 17.9 | 16.4 | 21.5 | 12.7 | C14 |
| FIG. 3e-5 | 39.0 | 17.3 | 14.8 | 18.4 | 10.5 | C14 |
| FIG. 3f-1 | 38.7 | 32.8 | 15.1 | 11.3 | 2.1 | BCC |
| FIG. 3f-2 | 39.6 | 31.6 | 14.9 | 11.8 | 2.1 | BCC |
| FIG. 3f-3 | 39.6 | 31.8 | 14.9 | 11.6 | 2.1 | BCC |
| FIG. 3f-4 | 43.3 | 27.8 | 14.1 | 13.0 | 1.9 | BCC |
| FIG. 3f-5 | 45.1 | 25.9 | 13.9 | 13.3 | 1.9 | BCC |
| FIG. 3g-1 | 40.5 | 29.9 | 16.1 | 12.0 | 1.5 | BCC |
| FIG. 3g-2 | 41.4 | 29.0 | 16.1 | 12.3 | 1.3 | BCC |
| FIG. 3g-3 | 42.1 | 27.9 | 15.9 | 12.9 | 1.2 | BCC |
| FIG. 3g-4 | 44.9 | 25.5 | 15.3 | 13.6 | 0.7 | BCC |
| FIG. 3g-5 | 46.7 | 23.6 | 14.9 | 14.3 | 0.6 | BCC |
| FIG. 3h-1 | 45.5 | 26.1 | 13.9 | 14.5 | 0.0 | BCC |
| FIG. 3h-2 | 43.6 | 28.2 | 14.5 | 13.6 | 0.0 | BCC |
| FIG. 3h-3 | 34.0 | 24.2 | 10.5 | 9.1 | 22.2 | La₂O₃ |
| FIG. 3h-4 | 16.1 | 10.4 | 1.0 | 5.6 | 66.9 | La₂O₃ |
| FIG. 3h-5 | 5.0 | 2.9 | 1.0 | 0.0 | 91.2 | La |

Compositions from the main BCC phase are shown in bold. Except for Alloy-B and Alloy-La, the substitution elements are present in BCC phase in the quality between 1.1 and 2.1 wt. %. Our EDS system cannot measure light elements, such as B. According to XRD and SEM-BEI analysis, B-predominating phase does not exist, therefore, B is assumed to be distributed in the BCC phase. The darker contrasts in Spots 3a-4, 3a-5, 3b-3, 3b-4, and 3b-5 are considered to be small TiO₂ particles embedded in the BCC matrix. Alloy-Mn, Alloy-Nb, and Alloy-Mo are very uniform in composition. In Alloy-Ni, TiNi phase was found in Spots 3d-4 and 3d-5. The C14 phase in Alloy-Zr has an inter-granular distribution since the BCC phase solidified first and pushed the Zr into the C14 phase. The average electron density (e/a) of this phase (5.06) is below the C14/C15 threshold [23, 24], yet another piece of evidence for C14 over C15 besides the XRD result. In Alloy-La without any annealing, there is no indication of La-participation in the main BCC phase. The La either forms a large metallic inclusion (Spot 3h-5), or an oxide suspended uniformly in the BCC matrix (Spot 3h-3) near the edge of the La-metal clusters (Spot 3h-4). The zero-solubility of La in BCC explains why addition of La does not change the lattice constant of BCC phase as illustrated in FIG. 2.

### Gaseous Phase Characteristics

Gaseous phase hydrogen storage properties of the alloys were studied by pressure-concentration-temperature (PCT) using a Suzuki-Shokan multi-channel PCT system. The chamber was filled with 7 MPa of hydrogen at 30° C., and then the absorption was calculated followed by a PCT-desorption measured at the same temperature. Each alloy was degassed at 400° C. for 2 h with a mechanical vacuum pump and then a full 60° C. absorption-desorption PCT was measured. Each alloy was degassed at 400° C. for 2 h again and followed by a 90° C. PCT measurement. Finally, each alloy was degassed at 400° C. for 2 h and a last 30° C. PCT measurement was performed. The resulting absorption and desorption isotherms measured at 30, 60, and 90° C. together with the initial 30° C. desorption isotherm are shown in FIGS. 4A-H with information obtained from the PCT study is summarized in Table 3.

TABLE 3

| | | | | | | 90° C. | |
|---|---|---|---|---|---|---|---|
| | | | | | | desorption | |
| | | 30° C. | 30° C. | 60° C. | 60° C. | pressure | 90° C. |
| | Initial | max | reversible | max | reversible | @ 2 wt. % | hysteresis |
| X = | max (%) | (%) | (%) | (%) | (%) | (MPa) | @ 2 wt. % |
| B | 3.48 | 3.38 | 1.73 | 3.43 | 1.00 | 0.011 | 1.7 |
| Si | 3.30 | 3.08 | 0.52 | 3.08 | 1.12 | 0.011 | 2.5 |
| Mn | 3.47 | 3.11 | 0.49 | 3.02 | 1.40 | 0.013 | 2.0 |
| Ni | 3.39 | 3.16 | 0.63 | 3.16 | 1.56 | 0.028 | 1.8 |
| Zr | 3.12 | 2.76 | 0.53 | 2.59 | 1.09 | 0.016 | 1.9 |
| Nb | 3.48 | 3.25 | 0.59 | 3.19 | 0.86 | 0.011 | 2.0 |
| Mo | 3.42 | 3.24 | 0.56 | 3.29 | 1.00 | 0.012 | 1.8 |
| La | 3.55 | 3.19 | 0.49 | 3.19 | 0.74 | 0.009 | 1.6 |

Most of the alloys show similar gaseous phase properties. The pristine alloys showed similar storage capacities (3.30 to 3.55 wt. %), except Alloy-Zr (3.12 wt. %). A storage capacity of 3.50 wt. % is equivalent to an electrochemical capacity of 938 mAh/g (based on 1 wt. % of hydrogen is equivalent to 268 mAh/g). Maximum storage capacities measured at 30 and 60° C. after 400° C. outgassing show the following trend: B>Mo˜Nb>La˜Ni˜Mn>Si>Zr. These capacities do not correlate well with the BCC unit cell volume with correlation factors R²=0.18 and 0.22 for 30 and 60° C. capacities, respectively and larger BCC unit cell corresponds to smaller capacity. While Alloy-B (FIG. 4A) shows the best reversibility at 30° C., Alloy-Mn (FIG. 4C) and Alloy-Ni (FIG. 4D) have better reversibility at 60° C. than others. Average reversible 30° C. storage capacity is about 0.5 wt. %, which is equivalent to an electrochemical discharge capacity of 134 mAh/g. The 90° C. desorption plateau pressure of Alloy-Ni is the highest, followed by Alloy-Zr.

The hysteresis of the PCT isotherm is defined as In (Pₐ/P_{d}), where Pₐ and P_{d} are the absorption and desorption equilibrium pressures at wt. % hydrogen storage, respectively. The hysteresis can be used to predict the pulverization rate of the alloy during cycling. Alloys with larger hysteresis have higher pulverization rates during hydriding/dehydriding cycles. In this series of alloys, only PCT hysteresis at 90° C. can be measured. All the substitutions except Si show the same or slightly lower hysteresis. PCT hysteresis is mainly from the energy required to elastically deform the lattice near the metal/metal hydride interface during hydrogenation. Substitution increases the chemical disorder and reduces the PCT hysteresis. Nb has the same BCC crystal structure as V and has little effect on the degree of disorder, changing little in the PCT hysteresis. Adding Si with covalent bonding may stiffen the lattice, requiring higher energy to expand MH phase in the host metal.

Due to the low plateau pressures in these alloys, the regular thermodynamic calculation cannot be performed. To compensate for this, the desorption equilibrium pressures at 30, 60, and 90° C. were used to estimate the changes in enthalpy (ΔH) and entropy (ΔS) by the equation:

ΔG=ΔH−TΔS=RT ln P (2)

where R is the ideal gas constant and T is the absolute temperature. Results of these calculations are listed in Table 4.

TABLE 4

| | −ΔH | −ΔS (J |
|---|---|---|
| X = | (kJ mol⁻¹) | mol⁻¹ K) |
| B | 67 | 181 |
| Si | 56 | 156 |
| Mn | 37 | 107 |
| Ni | 58 | 165 |
| Zr | 22 | 63 |
| Nb | 64 | 176 |
| Mo | 66 | 178 |
| La | 67 | 178 |

Compared to the base Alloy-Mn, all the substitutions decrease ΔH except Alloy-Zr, which indicates an increase in hydride stability. In the case of Alloy-Zr, the addition of C14 phase in the alloy facilitates hydrogen absorption through the synergetic effect between storage and catalytic phases [25] and destabilizes the hydride. ΔS, usually measured in the desorption isotherm, is an indication of how far the MH system is from a perfect, ordered situation. The theoretical value of ΔS is the entropy of hydrogen gas, which is close to −135 J mol⁻¹K⁻¹. In our calculation, all the substitutions except Zr decrease the ΔS below −135, an indication that a more ordered hydride was formed. The Alloy-Zr shows a relatively higher ΔS indicating a more disordered hydride was formed with the interaction of C14 secondary phase.

Interestingly, the PCT isotherms of Alloy-B (FIG. 4A), -Zr (FIG. 4E), -Nb (FIG. 4F), and -Mo (FIG. 4G) show a small plateau near 0.3 MPa on the 30° C. desorption curve. This plateau, although very small (about 0.1 to 0.15 wt. %), has a pressure slightly above one atmosphere and is believed to be an important catalytic phase as will be discussed below.

Electrochemical Characterization

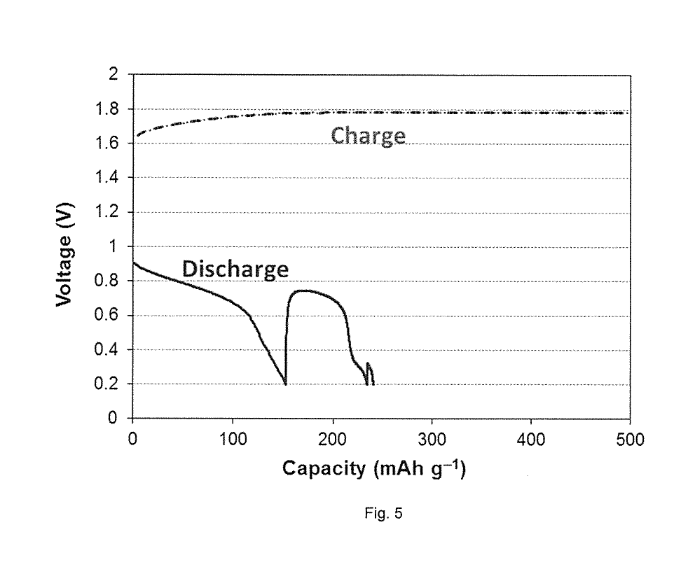

The discharge capacity of each alloy was measured in a flooded-cell configuration against a partially pre-charged Ni(OH)₂ positive electrode. Electrodes were made with powder after the PCT measurement that had been degassed four times at 400° C. for 2 h each. No alkaline pretreatment was applied before the half-cell measurement. Each sample electrode was charged at a constant current density of 50 mA/g for 10 h and then discharged at a current density of 50 mA/g followed by two pulls at 12 mA/g and 4 mA/g. The charge and discharge voltage curves for Alloy-Mo are shown in FIG. 5. The high charge voltage and low discharge voltage indicated large resistance through the poor-conducting TiO₂ surface. Electrolyte of 30% KOH is too corrosive for these BCC MH alloys. The capacities totaled up to certain rate are listed in Table 5.

TABLE 5

| | 1^{st} cycle Cap | 1^{st} cycle Cap | 1^{st} cycle Cap |
|---|---|---|---|
| X = | @ 50 mA/g | @ 12 mA/g | @ 4 mA/g |
| B | 81 | 163 | 179 |
| Si | 8 | 14 | 16 |
| Mn | 12 | 20 | 24 |
| Ni | 33 | 47 | 61 |
| Zr | 64 | 130 | 144 |
| Nb | 41 | 68 | 79 |
| Mo | 152 | 234 | 247 |
| La | 23 | 39 | 41 |

About 50% of the capacity was obtained at the highest rate used in this experiment: 50 mA/g. All substitution to Mn, except Si, show improvement in the first cycle capacity. The first cycle capacities are in the order: Mo>B>Zr>Nb>Ni>La>Mn>Si. Si showed the highest hysteresis and strongest resistance to hydrogen incorporation and thus a negative impact to the electrochemical storage. Alloy-Mo showed the highest discharge capacity at 247 mAh/g. The initial capacity for all alloys was significantly lower at the second cycle due to the highly corrosive nature of 30% KOH electrolyte, thus demonstrating the need for future improvements. It can be extrapolated that the original capacity without the KOH corrosion will be almost double that obtained in cycle one, therefore, electrochemical capacity near 500 mAh/g is possible with the electrolyte having no corrosion in V. In cycles 2 to 6, Alloy-Ni with a TiNi phase shows the highest discharge capacity due to the TiNi phase protecting some portion of the alloy without being totally corroded.

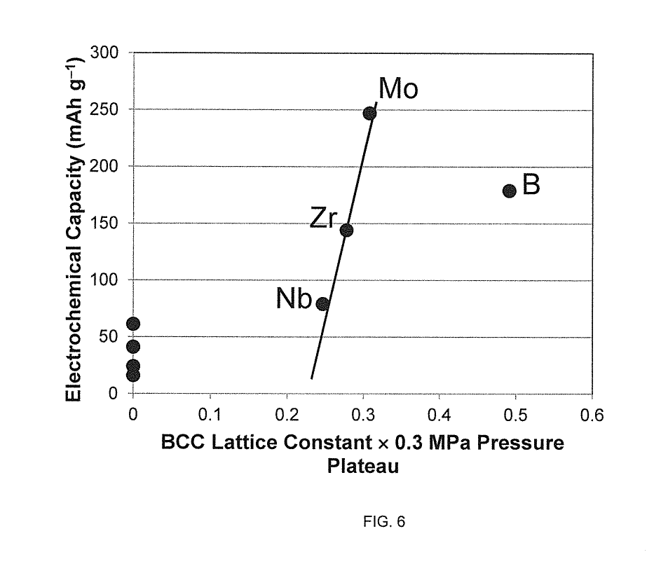

To further study the correlation between the electrochemical discharge capacity and other properties, the correlation factors (R²) from linear regression were calculated The correlation of discharge capacity to the BCC lattice constant is marginally significant (R²=0.29) (FIG. 6) showing that a larger unit cell does correlate to increased electrochemical capacity but not in a strictly linear relationship. In contrast, an excellent correlation was clearly present between the presence of the newly discovered plateau at 30° C. desorption isotherm near 0.3 MPa and discharge capacity. The alloys with the highest electrochemical discharge capacity all have the 0.3 MPa plateau. This plateau is from an intermediate hydride phase that can be catalytic and promote electrochemical reaction. When directly comparing the width of the plateau at around 0.3 MPa with the capacity, as can be seen in the list with the order of electrochemical capacity: Mo (0.10 wt. %), B (0.16 wt. %), Zr (0.09 wt. %), and Nb (0.08 wt. %), the direct correlation is poor. However, weighting the width of this plateau produces the correlation plotted in FIG. 6 with R²=0.70 when the product of plateau width and BCC unit cell parameter is used as a single factor. The correlation to transition metal substitution is even better as seen from the straight line connection points from Mo, Zr, and Nb. These data demonstrate that the electrochemical discharge capacity is dominated by both the BCC unit cell volume and the width of the catalytic plateau. The phase represented by the plateau enables the electrochemical application of the BCC-only alloys without contributions from an electrochemically active secondary phase. The highest discharge capacity of 247 mAh/g was obtained from Ti₄₀V₃₀Cr₁₅Mn₁₃Mo₂ alloy with both a catalytic hydride phase at around 0.3 MPa and an enlarged BCC unit cell. Further improvement of the electrochemical capacity of this alloy can reach as high as 500 mAh/g when non-corrosive electrolyte is used. Other substitution with B, Nb, and Zr also improve the electrochemical capacity but to a lesser degree.

### REFERENCES

[1] Young K, Fetcenko M A, Ouchi T, Im J, Ovshisky S R, Li F, Reinhout M. Hydrogen storage materials having excellent kinetics, capacity, and cycle stability, U.S. Pat. No. 7,344,676 (2008).
[2] Lee H, Chourashiya M G, Park C N, Park C J. Hydrogen storage and electrochemical properties of the Ti_{0.32}Cr_{0.43-x-y}V_{0.25}FeₓMn_{y} (x=0-0.055, y=0-0.080) alloys and their composites with MmNi_{3.99}Al_{0.29}Mn_{0.3}Co_{0.6} alloy, J Alloy Compd 2013; 566:37-42.
[3] Inoue H, Arai S, Iwakura C. Crystallographic and electrochemical characterization of TiV₄₋ₓNiₓ alloys for nickel-metal hydride batteries. Electrochim Acta 1996; 41:937-9.
[4] Mori T, Iba H. Hydrogen-absorbing alloy and hydrogen-absorbing alloy electrode, U.S. Pat. No. 6,338,764 B1 (2002).
[5] Yu X B, Wu Z, Xia B J, Xu N X. A Ti—V-based bcc phase alloy for use as metal hydride electrode with high discharge capacity. J Chem Phys 2004; 121:987-90.
[6] Chen N, Li R, Zhu Y, Liu Y, Pan H. Electrochemical hydrogenation and dehydrogenation mechanisms of the Ti—V base multiphase hydrogen storage electrode alloy. Acta Metall Sin 2004; 40:1200-4.
[7] Iba H, Akiba E. The relation between microstructure and hydrogen absorbing property in Laves phase-solid solution multiphase alloys. J Alloys Compd 1995; 231:508-12.
[8] Rönnebro E, Noréus D, Sakai T, Tsukahara M. Structural studies of a new Laves phase alloy (Hf,Ti)(Ni,V)₂ and its very stable hydride. J Alloys Compd 1995; 231:90-4.
[9] Tsukahara M, Takahashi K, Mishima T, Isomura A, Sakai T. V-based solid solution alloys with Laves phase network: Hydrogen absorption properties and microstructure. J Alloys Compd 1996; 236:151-5.
[10] Qiu S, Chu H, Zhang Y, Sun D, Song X, Sun L, et al. Electrochemical kinetics and its temperature dependence behaviors of Ti_{0.17}Zr_{0.08}V_{0.35}Cr_{0.10}Ni_{0.30} alloy electrode. J Alloys Compd 2009; 471:453-6.
[11] Young K, Nei J, Wong D F, Wang L, Structural, hydrogen storage, and electrochemical properties of Laves-phase related body-centered-cubic solid solution metal hydride alloys, Int J Hydrogen Energy (2014) http://dx.doi.org/10.1016/j.ijhydene.2014.01.134
[12] Iba H, Akiba E. Hydrogen absorption and modulated structure in Ti—V—Mn alloys. J Alloys Compd 1997; 253-254:21-4.
[13] Young K, Fetcenko M A, Li F, Ouchi T. Structural, thermodynamic, and electrochemical properties of TiₓZr₁₋ₓ(VNiCrMnCoAl)₂ C14 Laves phase alloys. J Alloys Compd 2008; 464:23 8-47.
[14] Young K, Fetcenko M A, Koch J, Morii K, Shimizu T. Studies of Sn, Co, Al, and Fe additives in C14/C15 Laves alloys for NiMH battery application by orthogonal arrays. J Alloys Compd 2009; 486:559-69.
[15] Yan Y, Chen Y, Liang H, Zhou X, Wu C. Tao M, et al. Hydrogen storage properties of V—Ti—Cr—Fe alloys. J Alloys Compd 2008; 454:427-31.
[16] Huot J, Akiba E, Ogura T, Ishido Y. Crystal structure, phase abundance and electrode performance of Laves phase compounds (Zr, A)V_{0.5}Ni_{1.1}Mn_{0.2}Fe_{0.2} (A=Ti, Nb or Hf). J Alloys Compd 1995; 218:101-9.
[17] Yoshida M, Akiba E. Hydrogen absorbing-desorbing properties and crystal structure of the Zr—Ti—Ni—Mn—V AB₂ Laves phase alloys. J Alloys Compd 1995; 224:121-6.
[18] Huot H, Akiba E, Ishido Y. Crystal structure of multiphase alloys (Zr,Ti)(Mn,V)₂. J Alloys Compd 1995; 231:85-9.
[19] Kuriiwa T, Tamura T, Amemiya T, Fuda T, Kamegawa A, Takamura H, et al. New V-based alloys with high protium absorption and desorption capacity. J Alloys Compd 1999; 293-295:433-6.
[20] Young K, Ouchi T, Fetcenko M A, Roes of Ni, Cr, Mn, Sn, Co and Al in C14 Laves phase alloys for NiMH battery application. J. Alloys Compd 2009; 476:774-81.
[21] Bendersky L A, Wang K, Levin I, Newbury A, Young K, Chao B, etc. Ti_{12.5}Zr₂₁V₁₀Cr_{8.5}MnₓCo_{1.5}Ni_{46.5-x} AB₂-type metal hydride alloys for electrochemical storage application: Part 1. Structural characteristics. J Power Sources 2012; 218:474-86.
[22] Smith J F, Lee K J. Lanthanum-Vanadium. In “Binary Alloy Phase Diagram”, ed Massalski T B, 2^{nd} ed. Vol. 3, Page 2437-2439, ASM International 1990, Ohio, USA.
[23] Johnson R L, Hoffmann R, Z Anorg Allg Chem 1992; 616:105-20.
[24] Nei J, Young K, Salley S O, Ng K Y S. Determination of C14/C15 phase abundance in Laves phase alloys. Mat Chem Phys 2012; 136:520-7.
[25] Nei J, Young K, Regmi R, Lawes G, Salley S O, Ng K Y S. Gaseous phase hydrogen storage and electrochemical properties of Zr₈Ni₂₁, Zr₇Ni₁₀, Zr₉Ni₁₁, and ZrNi metal hydride alloys. Int J Hydrogen Energy 2012; 37:16042-55.
[26] Young K, Nei J, Ouchi T, Fetcenko M A. Phase abundances in AB₂ metal hydride alloys and their correlations to various properties. J Alloys Compd 2011; 509:2277-84.

Patents, publications, and applications mentioned in the specification are indicative of the levels of those skilled in the art to which the invention pertains. These patents, publications, and applications are incorporated herein by reference to the same extent as if each individual patent, publication, or application was specifically and individually incorporated herein by reference.

In view of the foregoing, it is to be understood that other modifications and variations of the present invention may be implemented. The foregoing drawings, discussion, and description are illustrative of some specific embodiments of the invention but are not meant to be limitations upon the practice thereof. It is the following claims, including all equivalents, which define the scope of the invention.

1. A BCC metal hydride alloy comprising a pressure plateau with center at or between 0.1 MPa and 1.0 MPa and a plateau region between 0.05 weight percent to 0.5 weight percent of H₂ in the desorption PCT isotherm measured at 30° C.

2. The alloy of claim 1 wherein said equilibrium pressure plateau has a center between 0.2 and 0.5 MPa and the plateau region is between 0.05 weight percent to 0.5 weight percent of H₂.

3. The alloy of claim 1 wherein said equilibrium pressure plateau has a center between 0.2 and 0.5 MPa and the plateau region is between 0.1 weight percent to 0.3 weight percent of H₂.

4. The alloy of claim 1 free of electrochemically active secondary phase.

5. The alloy of claim 1 comprising an initial capacity of 70 milliampere hours per gram or greater.

6. The alloy of claim 1 comprising a modifier effective to enlarge the unit cell.

7. The alloy of claim 6 wherein said modifier is B, Zr, Mo, Nb, or combinations thereof.

8. The alloy of claim 1 comprising the composition of Formula I:
Ti_{w}VₓCr_{y}M_{z} (I)
where w+x+y+z=1, 0.1≦w≦0.6, 0.1≦x≦0.6, 0.01≦y≦0.6, and M comprises an element selected from the group consisting of Mn, Al, Si, Sn, and transition metals.

9. The alloy of claim 8 wherein M comprises Mn.

10. The alloy of claim 8 wherein M further comprises a modifier selected from the group consisting of B, Zr, Mo, Nb, or combinations thereof.

11. The alloy of claim 1 comprising a composition of Formula II:
Ti₄₀V₃₀Cr₁₅Mn₁₃X₂ (II)
where X═B, Zr, Nb, or Mo.

12. The alloy of claim 10 where X is Mo.

13. The alloy of claim 10 where X is B.

14. The alloy of claim 10 where X is Zr.

15. A metal hydride alloy comprising greater than 90 percent BCC phase and a capacity 60 milliampere hours per gram or greater measured at 25 degrees Celsius.

16. The metal hydride alloy of claim 15 comprising greater than 95 percent BCC phase.

17. The metal hydride alloy of claim 15 comprising greater than 99 percent BCC phase.

18. The metal hydride alloy of claim 15 wherein said capacity is 100 milliampere hours per gram or greater measured at 25 degrees Celsius.

19. The metal hydride alloy of claim 15 wherein said capacity is 200 milliampere hours per gram or greater measured at 25 degrees Celsius.

20. The metal hydride alloy of claim 15 comprising a pressure plateau with center between 0.2 MPa and 0.5 MPa in the desorption PCT isotherm measured at 30° C.
